(19) United States
(12) Patent Application Publication
(10) Pub. No.: US 2014/0325101 A1
(43) Pub. Date: Oct. 30, 2014

(54) DETERMINING A LOOP SET IDENTIFYING PORTS OF A ROUTING MODULE CONNECTED IN A STORAGE FABRIC LOOP

(71) Applicant: HEWLETT-PACKARD DEVELOPMENT COMPANY, L.P., Houston, TX (US)

(72) Inventors: Michael G. Myrah, Redmond, WA (US); Balaji Natrajan, Spring, TX (US); Chaowen Tan, Houston, TX (US)

(73) Assignee: HEWLETT-PACKARD DEVELOPMENT COMPANY, L.P., Houston, TX (US)

(21) Appl. No.: 13/873,416

(22) Filed: Apr. 30, 2013

(51) Int. Cl. G06F 3/06

(52) U.S. Cl. CPC G06F 3/0655; G06F 3/0613; G06F 3/067
USPC 710/74

(57) ABSTRACT

Examples disclosed herein relate to determining a loop set identifying ports of a routing module connected in a storage fabric loop. Examples include discovering at least a portion of a topology of a storage fabric comprising the routing module and a storage fabric loop including the routing module, determining a loop set identifying a plurality of ports of the routing module that are connected in the storage fabric loop, selecting one of the ports identified in the loop set, and indicating to a storage controller that no storage fabric component is connected to the routing module via the selected port.

### BACKGROUND

In computing systems, a storage network may include a storage fabric in which a storage controller communicates with a plurality of storage devices to store and retrieve information. Some or all of the storage devices may be remote from a computing device including the storage controller and may be connected to the storage controller via a plurality of routing modules. A routing module may be provided, in a storage enclosure containing a collection of the storage devices, in a networking device separate from such a storage enclosure, or in the computing device containing the storage controller, for example.

### BRIEF DESCRIPTION OF THE DRAWINGS

The following detailed description references the drawings, wherein:

FIG. 1 is a block diagram of an example routing module to determine a loop set identifying a plurality of ports of the routing module that are connected in a storage fabric loop;

FIG. 2A is a block diagram of an example system to indicate that no storage fabric component is connected to a routing module via a selected port included in a loop set, in response to a discovery request from a storage controller;

FIG. 2B is a diagram of an example flow of a discovery process of the routing module of FIG. 2A;

FIG. 2C is a diagram of an example plurality of loop sets that may be determined by the routing module of FIG. 2A;

FIG. 2D is a diagram of an example remaining loop set group generated by elimination of certain loop sets determined by the routing module of FIG. 2A;

FIG. 3 is a flowchart of an example method for indicating that no storage fabric component is connected to a routing module via a selected port of the loop set, in response to a discovery request from a storage controller; and

FIG. 4 is a flowchart of an example method for commanding a routing module to logically disable discovery through a target port by any storage controller.

### DETAILED DESCRIPTION

A storage fabric may include a storage controller connected to storage device(s) via routing module(s). As used herein, a “storage fabric” is an information storage system that includes at least one storage controller and a plurality of storage devices connected to send and receive input/output (I/O) communications to and from at least one of the storage controllers either directly or via at least one routing module. As used herein, a “routing module” is a switch, expander, or other device or component including a plurality of ports and capable of routing a communication received on one of the ports to another of the ports based on a destination address associated with the communication. Each port of a routing module may include at least one link interface. As used herein, a “port” is a physical communication interface of a component (e.g., storage controller, storage device, routing module, etc.) of a storage fabric. In some examples, a port may include at least one link interface. As used herein, a “link interface” may be a physical communication mechanism capable of exchanging communications over a physical link (e.g., wire(s), cable(s), etc.), wireless link, or the like. In some examples, a link interface may be a phy, a transceiver, or the like. In examples described herein, a phy may be a component including a transceiver that is capable of exchanging communications over a physical link. In examples described herein, a port may be a narrow port including one link interface or a wide port including a plurality of link interfaces, and a wide port is a single port regardless of how many link interfaces (e.g., phys, etc.) it includes.

In some situations, it may be desirable to interconnect a plurality of routing modules of a storage fabric to form a loop, which may be referred to herein as a “storage fabric loop.” For example, a storage fabric loop may provide multiple paths between a storage controller and a particular storage device, providing a choice of paths for routing optimization, redundancy, and the like. However, some storage fabric components may not be configured to accommodate storage fabric loops. For example, a storage controller, such as a Serial Attached Small Computer System Interface (SAS) initiator, may perform a discovery process in which it attempts to discover storage devices in the storage fabric. This process may include discovering routing modules in the storage fabric, and discovering components connected to each of the discovered routing modules. However, for an initiator not configured to accommodate loops, the discovery process may fall into an infinite loop when it reaches routing modules connected in a storage fabric loop.

To address these issues, examples described herein may provide a routing module to discover at least a portion of a topology of a storage fabric comprising the routing module and a storage fabric loop including the routing module, and determine, based on the discovered topology, a loop set identifying a plurality of ports of the routing module that are connected in the storage fabric loop. Examples described herein may further select one of the ports identified in the loop set and, in response to a discovery request from a storage controller targeting the selected port, indicate to the storage controller that no storage fabric component is connected to the routing module via the selected port. In this manner, examples described herein may hide a port connected in a storage fabric loop from a storage controller.

Examples described herein may further command another routing module to logically disable, for storage controllers, discovery through another port connected to the selected port. In this manner, examples described herein may logically break the storage fabric loop (i.e., by logically breaking one connection of the loop) for storage controller discovery and thereby prevent the storage fabric loop from causing the storage controller to enter an infinite loop during its discovery process. As such, examples described herein may enable the use of a storage controller that is unable to accommodate loops in a storage fabric including storage fabric loops, without alteration of the hardware or firmware (e.g., machine executable instructions) of the storage controller. Further, in examples described herein, routing modules may utilize an automated process to logically break storage fabric loops of a given storage fabric topology for storage controller discovery. In such examples, the automated process may logically break the loops in any of a plurality of different storage fabric topologies without the use of manual configuration to accommodate any particular topology.

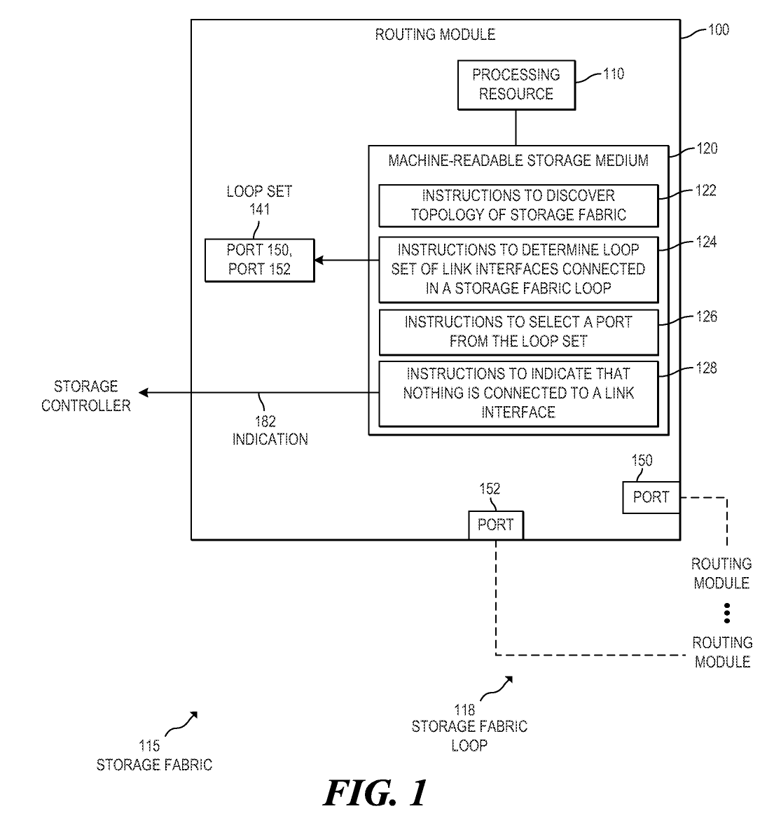

Referring now to the drawings, FIG. 1 is a block diagram of an example routing module 100 to determine a loop set identifying a plurality of ports of the routing module that are connected in a storage fabric loop 118. In the example of FIG. 1, routing module 100 includes a processing resource 110 and a machine-readable storage medium 120 encoded with (or otherwise comprising) instructions 122, 124, 126, and 128. In some examples, storage medium 120 may include additional instructions. In some examples, instructions 122, 124, 126, 128, and any other instructions described herein in relation to storage medium 120 may be stored on a machine-readable storage medium remote from but accessible to computing device 100 and processing resource 110.

In examples described herein, a processing resource may include, for example, one processor or multiple processors included in a single computing device or distributed across multiple computing devices. As used herein, a “processor” may be at least one of a central processing unit (CPU), a semiconductor-based microprocessor, a graphics processing unit (GPU), a field-programmable gate array (FPGA) configured to retrieve and execute instructions, other electronic circuitry suitable for the retrieval and execution instructions stored on a machine-readable storage medium, or a combination thereof. Processing resource 110 may fetch, decode, and execute instructions stored on storage medium 120 to perform the functionalities described below. In other examples, the functionalities of any of the instructions of storage medium 120 may be implemented in the form of electronic circuitry, in the form of executable instructions encoded on a machine-readable storage medium, or a combination thereof.

As used herein, a “machine-readable storage medium” may be any electronic, magnetic, optical, or other physical storage apparatus to contain or store information such as executable instructions, data, and the like. For example, any machine-readable storage medium described herein may be any of Random Access Memory (RAM), volatile memory, non-volatile memory, flash memory, a storage drive (e.g., a hard drive), a solid state drive, any type of storage disc (e.g., a Compact Disc Read Only Memory (CD-ROM), any other type of compact disc, a DVD, etc.), and the like, or a combination thereof. Further, any machine-readable storage medium described herein may be non-transitory.

In the example of FIG. 1, routing module 100 may be component of a storage fabric 115, which may comprise a storage controller and a storage fabric loop 118 including routing module 100. Routing module 100 may hide storage fabric loop 118 from the storage controller when the storage controller performs discovery, as described below. In some examples, storage fabric 115 may be a SAS storage fabric. In other examples, storage fabric 115 may be any other suitable storage fabric, such as a storage fabric utilizing another storage networking protocol (e.g., Fibre Channel Protocol (FCP), etc.). As used herein, a “storage controller” is a device able to request I/O operations at any of a plurality of storage devices via at least one routing module. Storage controllers may also request I/O operations at storage devices connected to the storage controller without any intervening routing module. A storage controller may be, for example, a disk array controller, a SAS initiator, an initiator of another storage networking protocol (e.g., FCP, etc.), or the like. In some examples, the storage controller may include at least one initiator port through which the storage controller may request I/O operations at a storage device. In some examples, a storage controller may be a hardware device, such as an expansion card (e.g., a Peripheral Component Interconnect (PCI) card), or another type of device comprising a printed circuit board.

As used herein, a “storage device” may be any machine-readable storage medium. For example, any storage device described herein may be a SAS drive (e.g., a SAS hard disk drive, a SAS solid-state drive (SSD), etc.), a Serial AT Attachment (SATA) drive (e.g., SATA hard disk drive), or the like. Additionally, in examples described herein, a routing module may be, for example, an SAS expander or a SAS switch including a SAS expander. Also, as used herein, a “storage fabric component” may be any hardware device capable of being connected to and exchanging communications via a port of a routing module. Example storage fabric components include storage controllers, routing modules, and storage devices.

In the example of FIG. 1, instructions 122 may discover at least a portion of a topology of storage fabric 115 comprising routing module 100 and storage fabric loop 118 including routing module 100. In examples described herein, the “topology” of a storage fabric may include at least the storage fabric components (e.g., storage controller(s), routing module(s), storage device(s), etc.) connected in the storage fabric and the connections between those components in the storage fabric. In the example of FIG. 1, storage fabric loop 118 may include routing module 100 and at least two other routing modules of storage fabric 115 interconnected with routing module 100 to form a loop.

In some examples, instructions 122 may perform a discovery process to discover the topology of storage fabric 115 (or a portion thereof). In such examples, by conducting the discovery process, instructions 122 may discover components connected to each of the ports of routing module 100. For example, instructions 122 may query each port of routing module 100 for identification of any component connected to routing module 100 via the port. In response, instructions 122 may receive an indication that no storage fabric component is connected to the port, or receive information describing the component connected to routing module 100 via the port. In some examples, the information describing the component may include an identification of the type of the connected component (e.g., storage controller, routing module, storage device, etc.) and an identifier for the component (e.g., an address for the component). In examples in which storage fabric 115 is a SAS fabric, the identifier for the component may be the SAS address of the component.

In response to determining that an end device (e.g., a storage controller or storage device) is connected to a particular port or that no storage fabric component is connected to the particular port, instructions 122 may cease discovery in relation to that port. In response to determining that a routing module is connected to a particular port, instructions 122 may continue the discovery process at the discovered routing module. For example, instructions 122 may discover the number of ports included in the discovered routing module. In examples in which storage fabric 115 is a SAS fabric, instructions 122 may request the number of ports by providing a REPORT GENERAL command to the discovered routing module, which may return the number of its ports in response.

After determining the number of ports at the discovered routing module, instructions 122 may repeat the above-described discovery process at the discovered routing module (excluding the port through which the routing module was discovered). Further, instructions 122 may repeat the above-described discovery process at each routing module discovered during the discovery process. In this manner, routing module 100 may traverse storage fabric 115 via a breadth-first search technique. In some examples, routing module 100 may perform the breadth-first search technique recursively to traverse the topology. In examples in which storage fabric 115 is a SAS fabric, instructions 122 may discover a component connected to a given port of a discovered routing module (e.g., a routing module other than routing module 100), or determine that no storage fabric component is connected to the given port, using a SAS management protocol (SMP) command.

In examples described herein, there may be three different conditions for terminating a particular path (branch, etc.) of the discovery process (i.e., of the breadth-first search traversal). First, a path of the discovery process may terminate when an end device (e.g., a storage controller, a storage device, etc.) is discovered as being connected to a port, or when no device is connected to the port. Second, a path of the discovery process may terminate when a routing module, previously discovered as being directly connected to routing module 100, is discovered as being connected to a port. In some examples, routing modules directly connected to routing module 100 are discovered at a second level of the breadth-first search traversal (where routing module 100 is considered to form the first level). In such examples, a path of the discovery process may terminate when a routing module discovered at the second level of the traversal is discovered again at a subsequent level. Third, a path of the discovery process may terminate when a routing module previously discovered in the path is discovered again. The second and third termination conditions for the discovery process may prevent the discovery process of routing module 100 from looping infinitely when the storage fabric contains storage fabric loop(s).

In the example of FIG. 1, instructions 124 may determine, based on the discovered topology, a loop set 141 identifying a plurality of ports of routing module 100 that are connected in storage fabric loop 118. In such examples, the discovered topology may include information regarding storage fabric components discovered (e.g., routing module(s), storage controllers, storage devices, etc.), information regarding where the components were discovered (i.e., through which other components of the storage fabric they were discovered, which may indicate connections of the storage fabric), ports through which the components were discovered, and the like. As used herein, a port “connected in” a storage fabric loop is a port of a given routing module of the storage fabric loop connecting the given routing module to another routing module of the storage fabric loop.

In the example of FIG. 1, instructions 124 may determine a loop set each time a path of the discovery process is terminated based on the second condition described above. For example, instructions 122 of routing module 100 may discover a second routing module connected to port 150, and may discover a third routing module connected to port 152. In such examples, the second and third routing modules may be considered part of the second level of the discovery process. Repeating the discovery process at the second routing module, routing module 100 may discover the third routing module via a port of the second routing module, and may then terminate the path through which the third routing module was re-discovered based on the second termination condition.

In response to terminating based on the second condition, instructions 124 may determine that routing module 100 and the second and third routing modules are connected in a storage fabric loop 118 (e.g., based on the routing modules in the terminated path). In some examples, instructions 124 may determine each of the ports of routing module 100 through which the third routing module was discovered, and generate a loop set including the determined ports. In the above example, instructions 124 may determine that the third routing module was discovered through port 152 and re-discovered through port 150, and may generate loop set 141 identifying ports 150 and 152. In some examples, loop set 141 may also identify the routing modules that are part of the discovered storage fabric loop 118. Instructions 124 may store loop set 141 in memory of routing module 100. In such examples, the memory may be a machine-readable storage medium. Loop set 141 may be stored in the memory in any suitable data structure or format, such as a list, a table, or the like.

In some examples, during the discovery process, instructions 122 may record the identities of the ports through which routing modules are discovered, in addition to recording the identities of the routing modules discovered. In such examples, in response to terminating based on the second condition, instructions 124 may re-trace the terminated path back to routing module 100 to determine the port of routing module 100 through which the path began, the routing modules in the storage fabric loop, or both. In such examples, instructions 124 may also determine the port of routing module 100 through which the third routing module was first discovered based on recorded information for the path through which it was first discovered. In other examples, instructions 124 may not use stored information to determine the ports connected in loop and may instead re-discover that information to identify in a loop set. For example, after determining the routing modules of storage fabric loop 118, instructions 124 may determine the ports connected in loop 118 (i.e., ports 150 and 152) by querying ports of routing module 100 to find the ports by which the routing modules of the determined storage fabric loop 118 are connected to routing module 100.

In the example of FIG. 1, instructions 126 may select one of the ports identified in loop set 141. For example, instructions 126 may select a port for which discovery through the port by storage controllers is to be logically disabled. As used herein, to “logically disable discovery” through a given port of a routing module is to configure the routing module to indicate that no storage fabric component is connected to the routing module via the given port in response to any discovery request from any storage controller. In some examples, a routing module may logically disable discovery through a given port by any storage controller such that the port may remain enabled for uses other than discovery by any storage controller. In some examples, the port may further remain enabled for any use other than discovery by any storage controller. For example, a routing module may logically disable discovery through a given port by any storage controller such that the given port remains available for communication routing. In examples described herein, communication routing via a given port of a routing module may include forwarding received communications to another storage fabric component via the given port and receiving, from another storage fabric component via the given port, communications to be forwarded by the routing module.

In some examples, instructions 126 may select one of the ports identified in loop set 141 if instructions 126 determine that routing module 100 is the master routing module for loop set 141 representing storage fabric loop 118 (including routing module 100). In examples described herein, a “master” routing module for a loop set is a routing module responsible for logically breaking, for storage controller discovery, the storage fabric loop represented by the loop set. In examples described herein, the master routing module for a loop set is one of the routing modules of the storage fabric loop represented by the loop set. The master routing module for a loop set may be distinguished in any suitable manner, such as having the highest or lowest identifier (e.g., address, SAS address) among the routing modules of the storage fabric loop represented by the loop set. An identifier (e.g., address) for each of the routing modules may be determined during the discovery process. In examples described herein, the master routing module (or “master”) for a loop set may also be referred to herein as the master routing module (or “master”) for a loop set representing the storage fabric loop.

Instructions 126 may select one of the ports identified in loop set 141 in any suitable manner in examples in which instructions 124 have not generated any other loop sets as a result of the discovery process. For example, instructions 126 may select one of the ports identified in loop set 141 randomly, based on port order in the loop set, or in any other suitable manner. In examples in which instructions 124 generate a plurality of loop sets as a result of the discovery process, instructions 126 may select ports from the loop sets such that at least one port in each loop set is selected.

For example, instructions 126 may select ports based on the number of loop sets the ports belong to. In such examples, instructions 126 may select the port belonging to the most loop sets from which no port has been selected, with ties being broken by any suitable manner, as described above. In some examples, instructions 126 may repeat this process until at least one port is selected from each loop set. In such examples, instructions 126 may further logically disable discovery through each of the selected ports by any storage controller. In some examples, instructions 126 may logically disable discovery through the selected port(s) by storage controllers by setting a respective flag for each selected port in routing module 100 (e.g., in memory, registers, etc.). In such examples, each selected port may remain available for the routing of communications by routing module 100 when the flag(s) are set for the selected port(s).

In some examples, storage controller(s) of storage fabric 115 may each perform their own discovery process to discover storage devices accessible in storage fabric 105. During this discovery process, a storage controller may provide to routing module 100 discovery requests targeting respective ports of routing module 100. As used herein, a discovery request targeting port of a routing module may be a request to discover any component connected to the routing module via the port, wherein the port (or a component thereof, such as a phy) is specified in the request.

In the example of FIG. 1, routing module 100 may receive a discovery request from a storage controller targeting the selected port. In response to the discovery request, instructions 128 may indicate to the storage controller that no storage fabric component is connected to routing module 100 via the selected port (e.g., that nothing is connected to routing module 100 via the selected port). For example, instructions 128 may indicate to the storage controller that no storage fabric component is physically connected to routing module 100 via the selected port. As an example, instructions 126 may select port 150 from loop set 141 and set a flag in routing module 100 to logically disable discovery through selected port 150 by storage controllers. In such examples, in response to receiving the discovery request, instructions 128 may determine that the discovery request is from a storage controller and is targeting selected port 150. For example, instructions 122 may record a list of each routing module discovered during the discovery process, and instructions 128 may determine that the discovery request is from a storage controller if the source address of the request does not match any of the addresses in the list of addresses of discovered routing modules. Instructions 128 may further determine that a flag is set for port 150 indicating that discovery through port 150 is logically disabled for storage controllers. In response to these determinations, instructions 128 may provide to the storage controller an indication 182 that no storage fabric component is connected to routing module 100 via selected port 150, though a routing module of storage fabric loop 118 is connected (i.e., physically connected) to port 150.

In the example of FIG. 1, a particular port of another routing module in storage fabric loop 118 may be connected to selected port 150 of the routing module. In some examples, instructions 126 may command the other routing module connected to selected port 150 (which is part of storage fabric loop 118) to logically disable discovery through the particular port of the other routing module that is connected to port 150. In such examples, in response to the command, the other routing module may logically disable discovery through the particular port by any storage controller, as described above. By logically disabling discovery through port 150 and the particular port connected to port 150, examples described herein may logically disable discovery by any storage controller via the connection between routing module 100 and the other routing module. In this manner, examples described herein may logically break storage fabric loop 118 for the discovery process of storage controllers of storage fabric 115. By logically breaking the loop in this manner, examples described herein may prevent storage controllers from entering an infinite loop as a result of storage fabric loop 118.

In the example of FIG. 1, instructions 128 may determine how to handle a discovery request from a storage controller and targeting a given port based on whether the flag is set for the given port. In such examples, when the flag is set for the given port, instructions 128 may indicate to the storage controller that no storage fabric component is connected to the routing module via the given port. When the flag is not set for the given port (i.e., discovery is not logically disabled for the given port), instructions 128 may return to the storage controller a response identifying whatever component is connected to the given port, if any. For example, in the example of FIG. 1, instructions 126 may not select port 152 identified in loop set 141, so the flag may not be set for port 152. In such examples, in response to a discovery request from a storage controller port 152, instructions 128 may return to the storage controller a response identifying a routing module connected to port 152 (e.g., one of the routing modules of storage fabric loop 118).

In some examples, instructions 122, 124, 126, and 128 may be part of an installation package that, when installed, may be executed by processing resource 110 to implement the functionalities described herein in relation to instructions 122, 124, 126, and 128. In such examples, storage medium 120 may be a portable medium, such as a CD, DVD, or flash drive, or a memory maintained by a server from which the installation package can be downloaded and installed. In other examples, instructions 122, 124, 126, and 128 may be part of an application, applications, or component already installed on routing module 100 including processing resource 110. In such examples, the storage medium 120 may include memory such as a hard drive, solid state drive, or the like.

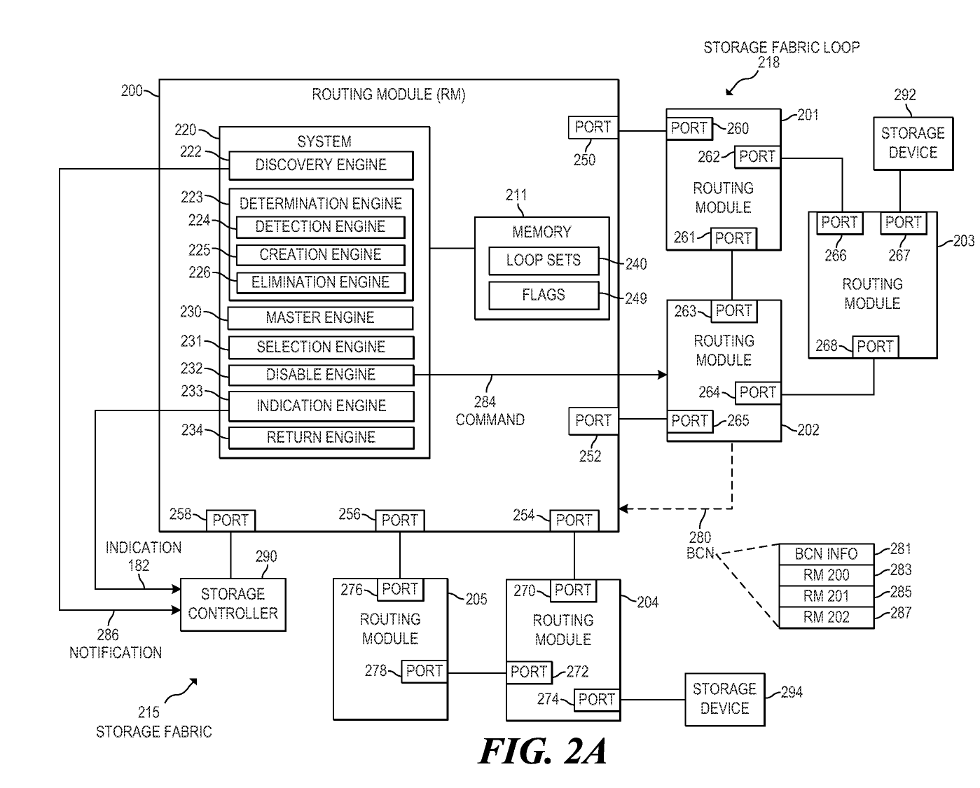

In some examples, each of the routing modules of storage fabric 115 may implement the functionalities described above in relation to routing module 100. For example, each of the routing modules may include a machine-readable storage medium comprising at least instructions 122, 124, 126, and 128 executable by a processing resource of the routing module. In some examples, functionalities described herein in relation to FIG. 1 may be provided in combination with functionalities described herein in relation to any of FIGS. 2A-4.

FIG. 2A is a block diagram of an example system 220 to indicate that no storage fabric component is connected to a routing module 200 via a selected port included in a loop set, in response to a discovery request from a storage controller. In the example of FIG. 2A, a storage fabric 215 includes routing modules 200-205, a storage controller 290, and storage devices 292 and 294. In other examples, storage fabric 215 may include a different number of routing module(s), storage device(s), storage controller(s), a different topology of those components, or a combination thereof. In some examples, storage fabric 215 may be a SAS fabric, and each of routing modules 200-205 may be a SAS expander.

Features of the example of FIG. 2A are described below in relation to an example discovery process and an example plurality of loop sets illustrated in FIGS. 2B-2D. FIG. 2B is a diagram of an example flow of a discovery process of routing module 200 of FIG. 2A, FIG. 2C is a diagram of an example plurality of loop sets 240 that may be determined by routing module 200 of FIG. 2A, and FIG. 2D is a diagram of an example remaining loop set group 248 formed by elimination of certain loop sets determined by routing module 200 of FIG. 2A.

In the example of FIG. 2A, routing module 200 includes a system 220 comprising engines 222-226 and 230-234. In some examples, system 220 may include additional engines. Each of the engines of system 220 may be any combination of hardware and programming to implement the functionalities of the respective engine. Such combinations of hardware and programming may be implemented in a number of different ways. For example, the programming for the engines may be processor executable instructions stored on a non-transitory machine-readable storage medium and the hardware for the engines may include a processing resource to execute those instructions. In such examples, the machine-readable storage medium may store instructions that, when executed by the processing resource, implement system 220. The machine-readable storage medium storing the instructions may be integrated in a routing module (or other computing device) including the processing resource to execute the instructions, or the machine-readable storage medium may be separate but accessible to the routing module and the processing resource. The processing resource may comprise one processor or multiple processors included in a single routing module (or other computing device) or distributed across multiple computing devices. In other examples, the functionalities of any of the engines may be implemented in the form of electronic circuitry.

In some examples, the instructions can be part of an installation package that, when installed, can be executed by the processing resource to implement system 220. In such examples, the machine-readable storage medium may be a portable medium, such as a CD, DVD, or flash drive, or a memory maintained by a server from which the installation package can be downloaded and installed. In other examples, the instructions may be part of an application, applications, or component already installed on a routing module including the processing resource. In such examples, the machine-readable storage medium may include memory such as a hard drive, solid state drive, or the like.

In the example of FIG. 2A, each of routing modules 200-205 may include a system 220, as described herein, to perform the functionalities described herein in relation routing module 200. Each of routing modules 200-205 may also include a plurality of ports. For example, routing module 200 includes ports 250, 252, 254, 256, and 258. In the example of FIG. 2A, storage controller 290 is connected to routing module 200 via port 258. Storage controller 290 may access storage devices 292 and 294 via routing modules 200-205. In the example of FIG. 2A, routing modules 200-205 are connected to form a plurality of storage fabric loops (such as storage fabric loop 218 including routing modules 200, 201, and 202). The storage fabric loops may provide storage controller 290 with multiple paths to the storage devices.

In the example of FIG. 2A, discovery engine 222 may discover at least a portion of a topology of storage fabric 215, which includes routing module 200, storage controller 290, and storage fabric loop 218 (including routing module 200), among other storage fabric loops. In some examples, discovery engine 222 may perform a discovery process as described above in relation to FIG. 1. For example, engine 222 may discover each component of storage fabric 215 by traversing storage fabric 215 via a breadth-first search technique, as described above. In such examples, discovery engine 222 may terminate paths of the breadth-first search based on the three different termination conditions described above.

Determination engine 223 may determine, based on information exchanged during the discovery, at least one loop set identifying a plurality of ports of routing module 200 that are connected in a storage fabric loop, such as storage fabric loop 218. For example, engine 223 may query ports of routing module 200, and of other discovered routing modules of storage fabric 215 and receive in response to each of the queries an indication that no storage fabric component is connected to the port, or receive information describing a component connected to the port. In such examples, engine 223 may determine loop set(s) based at least in part on the information exchanged during the discovery process. In such examples, the determination of loop set(s) by engine 233 may also be based on other information exchanged during the discovery process or otherwise determined by routing module 200 during the discovery process.

In some examples, determination engine 223 may include engines 224-226. In such examples, detection engine 224 may detect each storage fabric loop of storage fabric 215 that includes routing module 200. For example, engine 224 may detect a storage fabric loop including routing module 200 in response to a path of the breadth-first search traversal terminating based on the second termination condition described above. Creation engine 225 may create one or more loop sets 240 representing the detected storage fabric loop(s), respectively. Additionally, elimination engine 226 may eliminate redundancy among the loop set(s) 240 and may eliminate the larger of any overlapping loop sets among the loop set(s) 240, to thereby form a remaining loop set group 248 including at least one of the loop set(s) 240. The above-described functionalities of engines 224-226 may be performed during the discovery process, after the discovery process, or a combination thereof.

An example of the discovery process and the formation of the remaining loop set group 248 is described below in relation to FIGS. 2A-2D. Although the storage fabric loop detection, loop set generation, and loop set elimination are described concurrently with the discovery process below, any of the those functionalities may be performed concurrently with or after the discovery process, or a combination thereof. FIG. 2B includes a tree 213 illustrating a breadth-first search traversal of storage fabric 215 by routing module 200. The reference numerals of the routing modules of storage fabric 215 are the nodes of tree 213, and tree 213 includes arrows to indicate the direction of the traversal.

In the example of FIGS. 2A-2D, engine 222 may consider routing module 200 to be level 1 of the discovery process (illustrated as level 1 of tree 213). Engine 222 may then discover what is connected to each port of routing module 200. For example, engine 222 may discover routing modules 201, 202, 204, and 205 connected to ports 250, 252, 254, and 256 of routing module 200, respectively. The discovered routing modules 201, 202, 204, and 205 may be considered to form level 2 of the discovery process (i.e., level 2 of tree 213), which represents the routing modules directly connected to routing module 200. Engine 222 may also discover storage controller 290 (i.e., an end device) connected to port 258, and may thus terminate the path through port 258 based on the first termination condition.

Engine 222 may then discover what is connected to each port of each of discovered routing modules 201, 202, 204, and 205 (excluding the ports of those routing modules through which they were discovered). For routing module 201, engine 222 may discover what is connected to each of ports 261 and 262 of routing module 201 (and not port 260 through which routing module 201 was discovered). In such examples, engine 222 may discover routing modules 202 and 203 (see level 3 of tree 213) connected to ports 261 and 262 of routing module 201, respectively. For routing module 202, engine 222 may discover routing modules 201 and 203 (see level 3 of tree 213) connected to ports 263 and 264 of routing module 202, respectively (while ignoring port 265). For routing module 204, engine 222 may discover routing module 205 (see level 3 of tree 213) connected to port 272, while ignoring port 270, and may discover storage device 294 (i.e., an end device) connected to port 274. Engine 222 may thus terminate the path through port 274 according to the first termination condition. For routing module 205, engine 222 may discover routing module 204 (see level 3 of tree 213) connected to port 278, while ignoring port 276.

As noted above, the routing modules discovered through the routing modules of level 2 may form level 3 of the discovery process (and tree 213). At level 3, several paths are terminated according to the second termination condition. For example, engine 222 may determine that routing module 202 was previously discovered in level 2 (i.e., is directly connected to routing module 200), and may thus terminate the path at routing module 202. Detection engine 224 may detect the presence of a storage fabric loop including routing module 200 in response to the termination of the path based on the second condition. Engine 224 may further determine that the routing modules in the terminated path (e.g., routing modules 200, 201, and 202) are connected in the detected storage fabric loop including routing module 200 (e.g., storage fabric loop 218). Creation engine 225 may create a loop set representing the detected storage fabric loop and identifying ports of routing module 200 connected in the detected storage fabric loop. In some examples, the loop set may also identify the routing modules of the storage fabric loop.

For example, in response to terminating the path in response to discovering routing module 202 at level 3, as described above, engine 225 may detect the determine each of the ports of routing module 200 through which the re-discovered routing module 202 was discovered, and may create a loop set including the determined ports. For example, engine 225 may determine that routing module 202 was discovered through port 252 (at level 2), and through port 250 (i.e., via the terminated path). In such examples, engine 225 may create a loop set 241 (see FIG. 2C) identifying ports 252 and 250. In some examples, loop set 241 may also identify the routing modules of the terminated path (i.e., of the represented storage fabric loop). In such examples, engine 225 may retrace the terminated path to determine the routing modules to identify in the loop set. In the example of loop set 241, engine 225 may identify routing modules 202, 201, and 200 in loop set 241.

In the example of FIGS. 2A-2D, engine 222 may also determine that routing module 201 was previously discovered in level 2 (i.e., is directly connected to routing module 200), and may thus terminate the path that reaches routing module 201 at level 3 according to the second termination condition. In response, detection engine 224 may detect the presence of a storage fabric loop including routing module 200, and may determine that routing modules 201, 202, and 200 in the terminated path are connected in the storage fabric loop. Creation engine 225 may further create a loop set 242 (see FIG. 2C) representing the detected storage fabric loop, as described above. Loop set 242 may identify ports 250 and 252, and routing modules 201, 202, and 200.

Additionally, engine 222 may terminate the path that reaches routing module 205 at level 3 according to the second termination condition. In response, detection engine 223 may detect a storage fabric loop including routing module 200 and may determine that routing modules 205, 204, and 200 in the terminated path are connected in the storage fabric loop. Creation engine 225 may create a loop set 243 (see FIG. 2C) representing the detected storage fabric loop, as described above. Loop set 243 may identify ports 256 and 254, and routing modules 205, 204, and 200. Further, engine 222 may terminate the path that reaches routing module 204 at level 3 according to the second termination condition. In response, detection engine 223 may detect a storage fabric loop including routing module 200 and may determine that routing modules 204, 205, and 200 in the terminated path are connected in the storage fabric loop. Creation engine 225 may create a loop set 244 (see FIG. 2C) representing the detected storage fabric loop, as described above. Loop set 244 may identify ports 254 and 256, and routing modules 204, 205, and 200. Engine 225 may store loop sets 241-244 and any other of loop sets 240 in memory 211 of routing module 200. Memory 211 may be a machine-readable storage medium. Loop sets 240 may be stored in memory 211 in any suitable data structure or format, such as a list, a table, or the like.

Engine 222 may continue the discovery process for each non-terminated path. For example, for the path including routing modules 200, 201, and 203, engine 222 may continue discovery at 203. In such examples, engine 222 may discover routing module 202 (see level 4 of tree 213) through port 268 of routing module 203, and may discover storage device 292 (i.e., an end device) through port 267 of routing module 203, while ignoring port 266. Engine 222 may terminate the path through port 267 based on the first termination condition and may terminate the path through port 268 based on the second termination condition. In response to terminating the path based on the second condition, detection engine 223 may detect a storage fabric loop and determine that routing modules 202, 203, 201, and 200 in the terminated path ending at routing module 202 are connected in the storage fabric loop. In such examples, creation engine 225 may create a loop set 245 (see FIG. 2C) representing the detected storage fabric loop, as described above. Loop set 245 may identify ports 252 and 250, and routing modules 202, 203, 201, and 200.

Additionally, for the path including routing modules 200, 202, and 203 at level 3, engine 222 may continue discovery at routing module 203. In such examples, engine 222 may discover routing module 201 (see level 4 of tree 213) through port 266 of routing module 203, and engine 222 may terminate the path based on the second termination condition. In response, detection engine 223 may detect a storage fabric loop and determine that routing modules 201, 203, 202, and 200 in the terminated path ending at routing module 201 are connected in the storage fabric loop. In such examples, creation engine 225 may create a loop set 246 (see FIG. 2C) representing the detected storage fabric loop, as described above. Loop set 246 may identify ports 250 and 252, and routing modules 201, 203, 202, and 200.

In the example of FIGS. 2A-2D, elimination engine 226 may eliminate redundancy among the plurality of loop sets 240 and may eliminate the larger of any overlapping loop sets among loop sets 240, to thereby form a remaining loop set group 248 including at least one of loop sets 240. For example, as illustrated in FIG. 2D, engine 226 may determine loop sets that are redundant relative to one another and eliminate all but one of such loop sets. In some examples, engine 226 may determine that loop sets are redundant if they identify the same routing modules and ports. In other examples, engine 226 may determine that loop sets are redundant if they identify the same routing modules. In the example of FIGS. 2A-2D, engine 226 may determine that that loop sets 241 and 242 are redundant, since they identify the same routing modules and ports. In response to the determination, engine 226 may eliminate loop set 242. In other examples, engine 226 may eliminate loop set 241 instead. Additionally, engine 226 may eliminate loop set 244 (which is redundant relative to loop set 243) and may eliminate loop set 246 (which is redundant relative to loop set 245).

Elimination engine 226 may also eliminate the larger of any overlapping loop sets among loop sets 240. In examples described herein, a pair of loop sets overlap if a first one of the loop sets is smaller than a second one of the loop sets and is a subset of the second loop set. In the example of FIGS. 2A-2D, engine 226 may determine that loop sets 241 and 245 form a pair of overlapping loop sets, in which loop set 241 is a smaller subset of loop set 245. In response to the determination, engine 226 may eliminate loop set 245 (the larger of the overlapping loop sets). In this manner, engine 226 may form a remaining loop set group 248 including loop sets 241 and 243 by eliminating loop sets 242 and 244-246, as described above. In examples, described herein, the larger of a group of overlapping loop sets may be eliminated since logically breaking the storage fabric loop represented by the smaller loop set also logically breaks the storage fabric loop represented by the larger loop set.

In the example of FIGS. 2A-2D, master engine 230 may identify any loop set among the remaining loop set group 248 for which routing module 200 is the master, and selection engine 231 may select at least one port per loop set of remaining loop set group 248 for which routing module 200 is the master. For example, for each loop set of group 248, engine 230 may determine which routing module identified in the loop set is the master for the loop set. Engine 231 may select ports for which discovery through the ports by storage controllers is to be logically disabled. The master routing module for a loop set may be determined in any suitable manner, such as having the highest or lowest identifier (e.g., address, SAS address) among the routing modules of the storage fabric loop, as described above.

As an example, routing module 200 may have the largest SAS address among routing modules 200-205. In such examples, engine 230 may determine that routing module 200 is the master for both of loop sets 241 and 243. In such examples, engine 231 may select at least one port identified in each of loop sets 241 and 243, as described above in relation to FIG. 1. For example, engine 231 may select port 252 from loop set 241 and may select port 256 from loop set 243.

Disable engine 232 may logically disable discovery through each selected port by any storage controller, while allowing the selected ports to remain available for communication routing. In the above example, disable engine 232 may logically disable discovery through each of selected ports 252 and 256 by any storage controller, as described above. For example, engine 232 may logically disable discovery through selected ports 252 and 256 by setting flags 249 associated with each of the selected ports at routing module 200, as described above in relation to FIG. 1. For example, engine 232 may set the flags 249 in memory 211 of routing module 200.

Additionally, each of the selected ports of routing module 200 is connected to a port of another routing module of storage fabric 215, and disable engine 232 may further command other routing modules to logically disable discovery by any storage controller through any ports connected to any selected port of routing module 200. For example, selected port 252 is connected to port 265 of routing module 202 and selected port 256 is connected to port 276 of routing module 205. In such examples, in response to the selection of ports 252 and 256, disable engine 232 may command routing modules 202 and 205 to logically disable discovery through ports 265 and 276, respectively, by any storage controller. In some examples, engine 232 may command routing modules 202 and 205 to logically disable discovery by storage controllers through the ports such that the ports remain available for at least one use other than discovery by any storage controller. In some examples, engine 232 may provide a command 284 to routing module 202 to command routing module 202 to logically disable discovery through port 265 by any storage controller. In such examples, command 284 may identify the port for which discovery is to be logically disabled. Engine 232 may also provide such a command 284 identifying port 276 to routing module 205. In such examples, in response to receiving such a command, a routing module may logically disable discovery through a port identified in the command. In this manner, a connection of the storage fabric loop may be logically disabled for any storage controller.

As described above in relation to FIG. 1, storage controllers may also perform a discovery process. By logically disabling discovery by storage controllers for certain ports as described above, storage controllers may be prevented from entering an infinite loop during discovery. For example, logically disabling discovery by storage controllers through ports 256 and 276 may logically break the storage fabric loop formed by routing modules 200, 204, and 205 for storage controller discovery, such that the storage controllers do not fall into an infinite loop at that storage fabric loop. Also, logically disabling discovery by storage controllers through ports 252 and 265 may logically break the storage fabric loop formed by routing modules 200, 201, and 202, and the larger loop formed by routing modules 200, 201, 203, and 202 for storage controller discovery such that the storage controllers do not fall into an infinite loop at either of those storage fabric loops. In examples described herein, by breaking a loop that is a smaller subset of a larger loop (e.g., represented by a loop set that is a smaller subset of a larger loop set), examples described herein may logically break both loops in relation to storage controller discovery.

In some examples, routing module 200 may delay storage controller discovery until storage fabric loops of storage fabric 215 have been logically broken. In such examples, routing module 200 may receive a discovery request from a storage controller during a loop breaking process of routing module 200. In response to such a discovery request during the loop breaking process, discovery engine 222 may inform the storage controller that the routing module does not include any ports, to thereby prevent continued discovery of the storage controller at routing module 200. For example, in response to a discovery request from storage controller 290 during the loop breaking process, discovery engine 222 provide storage controller 290 a notification 286 indicating that routing module 200 does not include any ports. Engine 222 may determine whether a discovery request is from storage controller in any suitable manner. For example, in a storage fabric implementing zoning, routing modules may be assigned to a special zone group designated for routing modules (e.g., zone group 1), while storage controller(s) and storage device(s) are assigned to other zone group(s). Additionally, the discovery request may be preceded by a connection request to establish a connection with routing module 200, and the connection request may identify the zone group of the requester. In such examples, engine 222 may determine that a discovery request is from a storage controller when the discovery request is preceded by a connection request indicating that the requester is in a zone group other than the zone group designated for routing modules.

In such examples, after the loop breaking process, discovery engine 222 may further to provide to storage controller 290 another notification to cause the storage controller to perform discovery. For example, engine 222 may provide storage controller 290 a broadcast change notification (BCN) to cause storage controller 290 to restart its discovery process. In such examples, in response to a request from storage controller 290 after the loop breaking process, engine may provide to storage controller 290 an indication of at least the number of ports included in routing module 200. As such, storage controller 290 may continue its discovery process after routing module 200 has logically broken storage fabric loop(s), as described above. In some examples, the loop breaking process may be a process including the performance of the functionalities described above in relation to engines 222-226 and 230-232. In such examples, the loop breaking process may be finished when a discovery process of engine 222 is completed, and the functionalities of engine 223-226 and 230-232 related to that discovery process are completed. In other examples, storage controllers may be prevented from performing a discovery process during the loop breaking process in any other suitable manner.

During discovery by storage controller(s) after the loop breaking process, routing module 200 may receive a discovery request from a storage controller targeting one of the selected ports of routing module 200. In response, indication engine 233 may indicate to the storage controller that no storage fabric component is connected (i.e., physically connected) to the routing module via the targeted port. For example, in response to a discovery request from storage controller 290 targeting selected port 252, engine 233 may determine that port 252 is flagged (i.e., the flag is set for port 252) and in response may provide to storage controller 290 an indication 182 that no storage fabric component (i.e., nothing) is connected to routing module 200 via port 252.

Also after the loop breaking process, in response to another discovery request from the storage controller targeting a non-selected port of a loop set of routing module 200, return engine 234 may return to the storage controller information identifying a routing module connected to the targeted port. For example, in response to a discovery request from storage controller 290 targeting non-selected port 250 of loop set 241, return engine 234 may determine that port 250 is not flagged and thus may return to storage controller 290 information identifying routing module 201 connected to targeted port 250. In such examples, storage controller 290 is allowed to perform discovery through the non-selected port.

Although examples illustrated in FIGS. 2A-2D have been described above in relation to routing module 200 being the master of multiple loop sets, in other examples, determination engine 224 may determine a single loop set of which routing module 200 is the master and from which selection engine 231 may select an identified port, as described above in relation to FIG. 1. For example, routing module 205 may have a larger SAS address than routing module 200. In such examples, routing module 200 may be the master for loop set 241, while routing module 205 is the master for loop set 243. In such examples, engine 231 may select a port identified in loop set 241, but not any port identified in loop set 243. In such examples, in response to the selection, disable engine 232 may logically disable discovery through the selected port by any storage controller, as described above.

A broadcast change notification (BCN) indicating, for example, a change in a storage fabric may be received and forwarded by the routing modules of the storage fabric. To prevent excessive cycling of BCNs in a storage fabric including storage fabric loop(s), storage fabric 215 may utilize source information in a BCN to determine whether to forward the BCN. For example, for any BCN generated or forwarded by routing module 200, discovery engine 222 may add to the BCN an identification of routing module 200 as a source of the BCN. In such examples, storage fabric 215 may utilize zoned BCNs, or any other suitable type of BCN to which source information may be added. In some examples, each routing module the forwards a BCN may add to the BCN information identifying itself.

In such examples, in response to receiving a BCN at routing module 200, discovery engine 222 may determine whether the received BCN identifies routing module 200 as a source of the BCN. In response to a determination that the received BCN identifies routing module 200 as a source of the BCN, discovery engine 222 may determine not to forward the received BCN to any other component of storage fabric 215. In response to a determination that the received BCN does not identify routing module 200 as a source of the BCN, discovery engine 222 may determine to forward the received BCN to at least one other component of storage fabric 215. In such examples, routing module 200 may forward the BCN.

For example, engine 222 may generate a BCN 280 including BCN information 281 related to the change triggering the BCN, for example, and include information 283 identifying routing module 200 as a source of BCN 280. Engine 222 may provide BCN 280 to routing module 201, which may add information 285 identifying itself and then forward BCN 280 to routing module 202. Routing module 202 may add information 287 identifying itself, and then forward BCN 280 to routing module 200, which may determine that BCN 280 includes information 283 identifying routing module 200 as a source of the BCN 280, and in response determine not to forward BCN 280. In other examples, storage fabric 215 may prevent excessive cycling of BCNs in any other suitable manner. In some examples, functionalities described herein in relation to FIGS. 2A-2D may be provided in combination with functionalities described herein in relation to any of FIGS. 1 and 3-4. Also, although some functionalities are described herein in the context of a storage fabric implementing zoning, functionalities described herein also may be utilized in other contexts, such as storage fabrics not implementing zoning.

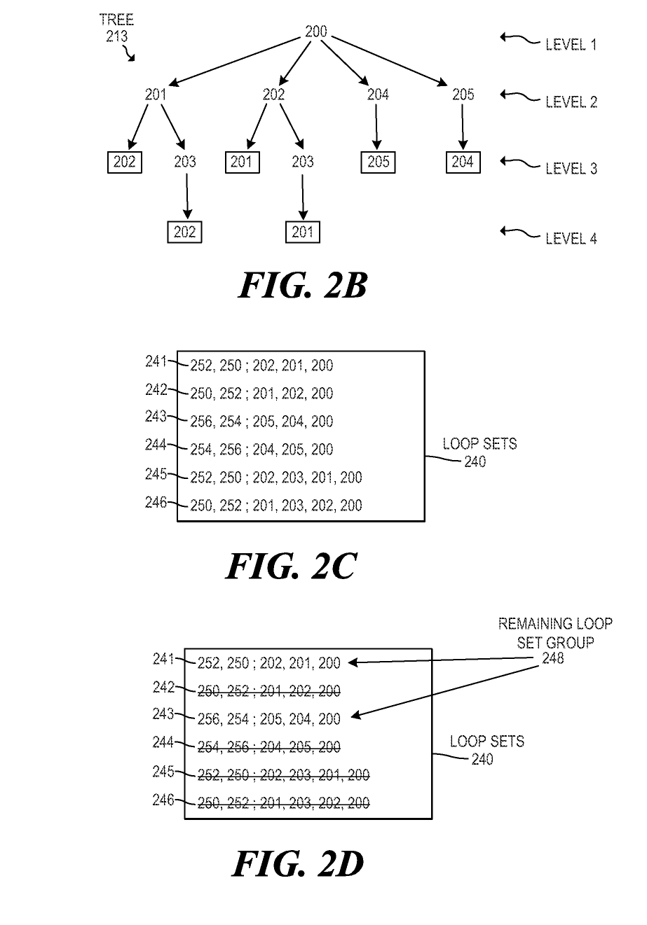

FIG. 3 is a flowchart of an example method for indicating that no storage fabric component is connected to a routing module via a selected port of the loop set, in response to a discovery request from a storage controller. Although execution of method 300 is described below with reference to system 220 of FIG. 2A, other suitable systems for execution of method 300 can be utilized (e.g., routing module 100). Additionally, implementation of method 300 is not limited to such examples.

At 305 of method 300, discovery engine 222 of routing module 200 may discover at least a portion of a topology of storage fabric 215 including routing module 200, a storage controller 290, and at least one storage fabric loop 218 including routing module 200. For example, engine 222 may perform the routing module discovery process described above in relation to FIGS. 1 and 2A-2B. At 310, determination engine 223 may determine, based on the discovered topology, a loop set identifying a plurality of ports of routing module 200 that are connected in storage fabric loop 218. For example, engine 223 may determine, based on the discovered topology, a loop set 241 (see FIG. 2C) identifying a plurality of ports (e.g., 250 and 252) of routing module 200 that are connected in storage fabric loop 218.

At 315, master engine 230 may identify routing module 200 as a master routing module for loop set 241. At 320, in response to the identification of routing module 200 as the master, selection engine 231 may select one of the ports identified in loop set 241, as described above. For example, selection engine 231 may select port 252 identified in loop set 241. At 325, in response to a discovery request from storage controller 290 targeting selected port 252, indication engine 233 may indicate to storage controller 290 that no storage fabric component is connected (i.e., physically connected) to routing module 200 via selected port 252.

Although the flowchart of FIG. 3 shows a specific order of performance of certain functionalities, method 300 is not limited to that order. For example, the functionalities shown in succession in the flowchart may be performed in a different order, may be executed concurrently or with partial concurrence, or a combination thereof. In some examples, functionalities described herein in relation to FIG. 3 may be provided in combination with functionalities described herein in relation to any of FIGS. 1-2D and 4.

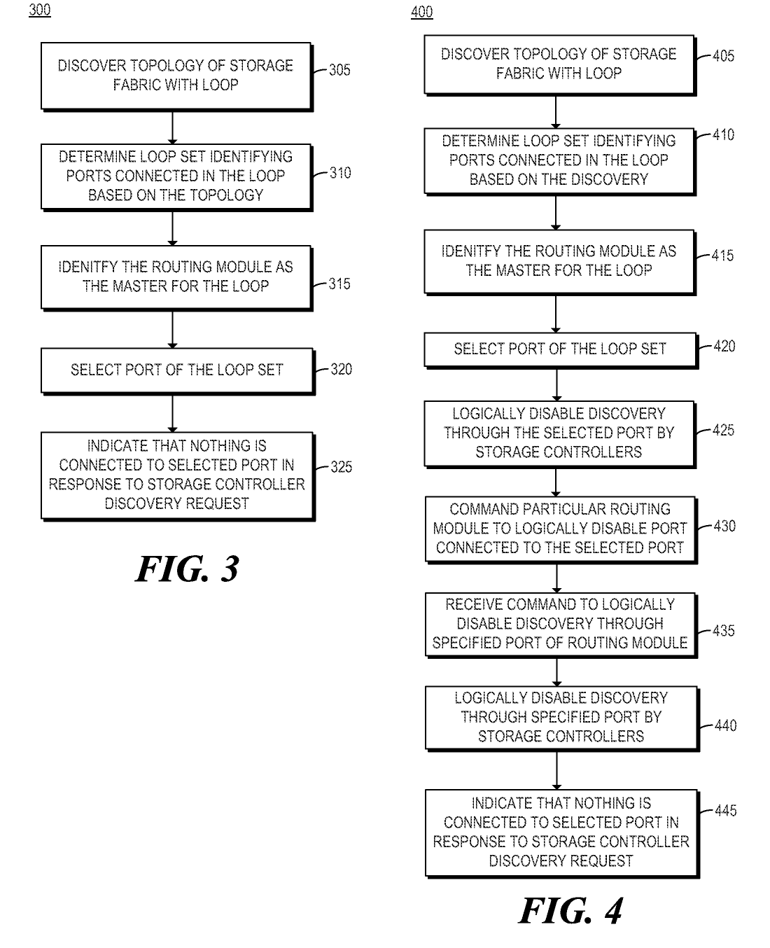

FIG. 4 is a flowchart of an example method for commanding a routing module to logically disable discovery through a target port by any storage controller. Although execution of method 400 is described below with reference to system 220 of FIG. 2A, other suitable systems for execution of method 400 can be utilized (e.g., routing module 100). Additionally, implementation of method 400 is not limited to such examples.

At 405 of method 400, discovery engine 222 of routing module 200 may discovering at least a portion of a topology of storage fabric 215 including routing module 200, a storage controller 290, and at least one storage fabric loop 218. For example, engine 222 may perform the routing module discovery process described above in relation to FIGS. 1 and 2A-2B. At 410, determination engine 223 may determine, based on the discovered topology, a loop set identifying a plurality of ports of routing module 200 that are connected in storage fabric loop 218. For example, engine 223 may determine, based on the discovered topology, a loop set 241 (see FIG. 2C) identifying a plurality of ports (e.g., 250 and 252) of routing module 200 that are connected in storage fabric loop 218.

At 415, master engine 230 may identify routing module 200 as a master routing module for loop set 241. At 420, in response to the identification of routing module 200 as the master, selection engine 231 may select one of the ports identified in loop set 241, as described above. For example, selection engine 231 may select port 252 identified in loop set 241. At 425, disable engine 232 may logically disable discovery through selected port 252 by any storage controller and such that the specified port remains available for communication routing, as described above. At 430, disable engine 232 may command routing module 202, including a port 265 connecting routing module 202 to selected port 252, to logically disable discovery through port 265 by any storage controller and such that port 265 remains available for communication routing. In such examples, in response to the command, routing module 202 may logically disable discovery through port 265 by any storage controller, as described above.

At 435, routing module 200 may receive, from another routing module (e.g., routing module 205), a command to logically disable discovery by any storage controller through a specified port (e.g., port 256) of routing module 200 different than selected port 252. At 440, in response to the command, disable engine 232 may logically disable discovery through the specified port (e.g., port 256) by any storage controller and such that discovery through the specified port remains available for communication routing. At 445, in response to a discovery request from storage controller 290 targeting selected port 252, indication engine 233 may indicate to storage controller 290 that no storage fabric component is connected (i.e., physically connected) to routing module 200 via selected port 252.

Although the flowchart of FIG. 4 shows a specific order of performance of certain functionalities, method 400 is not limited to that order. For example, the functionalities shown in succession in the flowchart may be performed in a different order, may be executed concurrently or with partial concurrence, or a combination thereof. Functionalities described herein in relation to FIG. 4 may be provided in combination with functionalities described herein in relation to any of FIGS. 1-3.

What is claimed is:

1. A non-transitory machine-readable storage medium comprising instructions executable by a processing resource of a routing module to:
discover at least a portion of a topology of a storage fabric comprising the routing module and a storage fabric loop including the routing module;
determine, based on the discovered topology, a loop set identifying a plurality of ports of the routing module that are connected in the storage fabric loop;
select one of the ports identified in the loop set; and
in response to a discovery request from a storage controller targeting the selected port, indicate to the storage controller that no storage fabric component is connected to the routing module via the selected port.

2. The storage medium of claim 1, wherein the instructions to select further comprise instructions to:
logically disable discovery through the selected port by any storage controller such that the selected port remains available for communication routing.

3. The storage medium of claim 2, wherein:
a particular port of another routing module in the storage fabric loop is connected to the selected port of the routing module; and
the instructions to select further comprise instructions to command the another routing module to logically disable discovery through the particular port by any storage controller such that the particular port remains available for communication routing.

4. The storage medium of claim 3, wherein the instructions to indicate further comprise instructions to:
in response to another discovery request from the storage controller targeting another one of the plurality of ports, return to the storage controller a response identifying a given routing module connected to the another one of the ports.

5. The storage medium of claim 1, wherein:
the storage fabric is a Serial Attached Small Computer System Interface (SAS) fabric; and
the routing module is a SAS expander.

6. A routing module comprising:
a discovery engine to discover at least a portion of a topology of a storage fabric comprising the routing module, a storage controller, and a given storage fabric loop including the routing module;
a determination engine to determine, based on information exchanged during the discovery, a given loop set identifying a plurality of ports of the routing module that are connected in the given storage fabric loop;
a selection engine to select a first one of the plurality of ports identified in the given loop set;
an indication engine to, in response to a discovery request from the storage controller targeting the first port, indicate to the storage controller that no storage fabric component is connected to the routing module via the selected port; and
a return engine to, in response to another discovery request from the storage controller targeting a second one of the ports, return to the storage controller information identifying another routing module connected to the second port.

7. The routing module of claim 6, further comprising:
a disable engine to, in response to the selection, logically disable discovery through the first port by any storage controller such that the first port remains available for at least one use other than discovery by any storage controller.

8. The routing module of claim 7, wherein:
the disable engine is further to, in response to the selection, command a particular routing module to logically disable discovery through a particular port by any storage controller such that discovery through the particular port remains available for at least one use other than discovery by any storage controller;
the particular routing module includes the particular port and is connected to the first port of the routing module via the particular port;
the storage fabric is a Serial Attached Small Computer System Interface (SAS) fabric; and
the routing module is a SAS expander.

9. The routing module of claim 6, wherein:
during a loop breaking process, the discovery engine is further to inform the storage controller that the routing module does not include any ports; and
after the loop breaking process, the discovery engine is further to provide to the storage controller a notification to cause the storage controller to perform discovery; and
in response to a request from the storage controller after the loop breaking process, the discovery engine is further to provide to the storage controller the number of ports included in the routing module.

10. The routing module of claim 6, wherein the determination engine further comprises:
a detection engine to detect each of a plurality of storage fabric loops of the storage fabric that include the routing module, the plurality of storage fabric loops comprising the given storage fabric loop;
a creation engine to create a plurality of loop sets representing the plurality of storage fabric loops, respectively, the plurality of loop sets including the given loop set and each identifying a respective plurality of ports; and
an elimination engine to eliminate redundancy among the plurality of loop sets and to eliminate the larger of any overlapping loop sets, to thereby form a remaining loop set group including at least one of the plurality of loop sets.

11. The routing module of claim 10, further comprising:
a master engine to identify any loop set among the remaining loop set group for which the routing module is the master, wherein the selection engine is to select at least one port per loop set of the remaining loop set group for which the routing module is the master; and
a disable engine to logically disable discovery through each selected port by any storage controller such that each selected port remains available for communication routing.

12. The routing module of claim 6, wherein:
the discovery engine is further to, in response to receiving a broadcast change notification (BCN), determine whether the received BCN identifies the routing module as a source of the BCN;
the discovery engine is further to, in response to a determination that the received BCN identifies the routing module as a source of the BCN, determine not to forward the received BCN to any other component of the storage fabric; and
the discovery engine is further to, for any BCN generated or forwarded by the routing module, add to the BCN an identification of the routing module as a source of the BCN.

13. A method comprising:
discovering, with a given routing module, at least a portion of a topology of a storage fabric comprising the given routing module, a storage controller, and a storage fabric loop including the given routing module;
determining, based on the discovered topology, a loop set identifying a plurality of ports of the given routing module that are connected in the storage fabric loop;
identifying the given routing module as a master routing module for the loop set;
in response to the identification of the given routing module as the master, selecting one of the ports identified in the loop set; and
in response to a discovery request from the storage controller targeting the selected port, indicating to the storage controller that no storage fabric component is physically connected to the given routing module via the selected port.

14. The method of claim 13, further comprising:
logically disabling discovery through the selected port by any storage controller such that the selected port remains available for communication routing;
commanding a particular routing module, including a particular port connecting the particular routing module to the selected port, to logically disable discovery through the particular port by any storage controller such that the particular port remains available for communication routing.

15. The method of claim 14, further comprising:
receiving, from another routing module, a command to logically disable discovery by any storage controller through a specified port of the routing module different than the selected port; and
in response to the command, logically disable discovery through the specified port by any storage controller such that the specified port remains available for communication routing.
